(19) United States
(12) Patent Application Publication
(10) Pub. No.: US 2019/0155943 A1
(43) Pub. Date: May 23, 2019

(54) SITUATIONAL ADVICE APPLICATION SYSTEM & METHOD

(71) Applicants: Stephen James Moraga, Newport Beach, CA (US); John O'Donnell, Newport Beach, CA (US); Anthony Jackson, Newport Beach, CA (US)

(72) Inventors: Stephen James Moraga, Newport Beach, CA (US); John O'Donnell, Newport Beach, CA (US); Anthony Jackson, Newport Beach, CA (US)

(21) Appl. No.: 15/820,414

(22) Filed: Nov. 21, 2017

(51) Int. Cl. G06F 17/30

(52) U.S. Cl. CPC G06F 17/30684; H04L 51/32; G06F 17/30654; G06F 17/30867

(57) ABSTRACT

Management of user-generated situational advice is disclosed. The present invention allows for a user to ask a question regarding various situations and receive advice from one or more advisors. The situational advice is pervasive and easily accessible to users via a computer or smart phone in addition to being accurate and credible such that users can trust or rely upon the rendered advice from the advisors.

### FIELD OF THE INVENTION

This invention relates in general to a system and methods for automatically generating sequences of tailored messages, particularly messages dealing with information related to Situational Advise.

### BACKGROUND OF THE INVENTION

There are many systems known for attempting to make matches between individuals. The typical goal of many of these systems is dating. They attempt to match individuals into pairs that are likely to decide to form a lasting couple. Many systems use self-reporting survey results regarding the individuals' characteristics, likes, and dislikes. However, daily life is increasingly challenging for individuals and couples. What is really needed, is an automated system to help individuals as well as couples regarding Situational Advice.

A system that is geared to help (the user) make proper decisions in certain Situations. The system is designed to alleviate having to live and learn through years of life experience. This gives the user an opportunity to skip right to the knowledge and wisdom discovered much later in life and have that knowledge now instead of having to have learn it over time.

The people who use this system ultimately save time, and will hopefully learn to make decisions they are proud of and can stand behind without looking like an idiot. We want people to be confident with what they choose to do, in the decisions they make.

The point is to improve life for all audiences by producing the world's finest social media system geared towards the issues that our target demographic deals with daily and be able to advise them as to the proper decision as Knowledge is Power.

It is an object to produce a brand based off our lifestyle system that integrates the concept utilizing the latest and greatest technologies available.

It is also an object of this invention to create user experiences, wherein we would place them into situations that they would previously not be able to achieve and advise them accordingly.

Our initial target audience will be young men & women ages 17-32 by producing the first social media situational advice system geared towards issues that each demographic struggles with in its day to day life.

It is also an object of this invention to improve life for all audiences. In the future we will open roll out additional advice systems that are geared for every age group and gender.

Based on older traditions of advice columns in newspapers, and magazines, this invention will seek to integrating these solutions and methods onto a platform that is more readily accessible to the current generation and to current technology and thereby producing the first social media Situational Advice System geared towards issues that each demo struggles with.

### SUMMARY OF THE INVENTION

Mission Statement of this invention is to provide people with the tools and support they need to make the best decisions possible.

It is an object of this invention to create a fun, interactive environment to provide people, ages 17 and up, with invaluable situational advice for the challenges they will face in life.

It is a further object of this invention to create a Situational Advice Application System and Method that is geared to help (the user) make proper decisions in certain Situations. The system is designed to alleviate having to live and learn through years of life experience. This gives the user an opportunity to skip right to the knowledge and wisdom discovered much later in life and have that knowledge now, instead of having to have learn it over time.

It is also an object of this invention to create a Situational Advice Application System and Method having a panel of experts that could be tapped for their knowledge and experience in different categories of questions.

One way this assistance is provided is in the form of a sequence of tailored automated messages for the main user based on generic questions.

The messages can suggest specific actions to be taken with respect to specific Situations for the main user.

The content of the messages can be determined by answers to survey questions.

In addition, with some versions, each member can nominate a small group of third parties to help them with their Situation.

The inclusion of helpful third parties can create a very personalized overall experience with the third parties' input adding to the tailored automated messages.

It is an object of this invention to utilize older traditions of advice columns in newspapers, and magazines, which this invention will seek to integrating these solutions and methods onto a platform that is more readily accessible to the current generation and to current technology and thereby producing the first social media Situational Advice System geared towards issues that each demo struggles with.

It is an object of this invention to utilize a system that is geared to help (the user) make proper decisions in certain Situations. The system is designed to alleviate having to live and learn through years of life experience. This gives the user an opportunity to skip right to the knowledge and wisdom discovered much later in life and have that knowledge now instead of having to have learn it over time.

A stream of advice content can be composed by a system by automatically selecting from pre-determined content, the selecting being done based on characteristics of the first member and characteristics of the Situation.

A stream of advice content can be composed by a system by automatically selecting from pre-determined content, the selecting being done based on characteristics of the first member, characteristics of the second member and characteristics of the Situation.

Some embodiments can include suggestions from one or more groups of cooperating third parties via an interface that keeps each group's suggestions separate and not accessible by anyone other than members of the inputting group and the main user.

It is also an object of this invention to utilize a Situational Advice Application System and Method to bring millions up to speed on social interaction, by providing real life advice in an option of trivia forum.

It is a further object of this invention to utilize a Situational Advice Application System and Method to give advice and receive advice for all of their issues and troubles in a social advice system and advice centric social network.

It is another object of this invention to utilize a Situational Advice Application System and Method to give advice and receive advice in a video game setting, wherein the use can be one of the characters in a virtual world that is experiencing life's decisions.

It will help people interact better with others when in front of someone rather than behind a computer or phone. This will be used to replace advice columns in magazines.

It is an object of this invention in an alternative embodiment to create a game wherein the user will role play by providing real life experiences to trigger Situational Advice in the form of a game.

In the alternative embodiment, What's The Play is a social gaming system that challenges player to choose the “best” response to various real-life situations and encounters. Using the well know trivia game format, users are presented with a series of situational questions from one or more categories and scored based upon their choices and responses. Users answers are scored in one of three ways:
Expert Opinion—the users choice is scored against the expert advice offered by whats the plays content designers
Mob Rules—the users choice is scored based upon the cumulative choices of every user who has answered the question.
Survey Says—the users choice is scored against all the players currently playing in the same gaming session as the user.

In the alternative embodiment, the application is designed to provide a virtual playing field for real-life social party games and as such the application is locationally aware, using the players mobile to device to determine the current location, allowing users to connect with and interact with players at their current or nearby locations and to compete as individuals and in teams. Integration with the devices calendar and push notification system allow players to schedule and take part in current and upcoming events in the real-world locations around them. Integration and hooks into many of the most popular social media systems allows users to share their victories, request backup, and invite friends to participate with them. Commercial establishments and venues such as bars and restaurants can opt into the system, providing contextual playing fields for the competitors in the application. This physical establishments can sponsor recurring or one-off events, providing users with the chance to compete in a real world venue for fun and fame, and potentially some prizes as well.

The alternative embodiment could also include interesting or unique points for the system such as:
The use of the mobile device as a playing screen for a real-world/location based competition.
Geofencing of play locations and venues.
Locationally aware gameplay, where the device alerts the user as they cross into a geofence, potentially altering the mode and form of play.
Use of the devices maps application to help players find physical situational locations.

It is still yet another object of this invention to utilize a Situational Advice Application System and Method where people are sharing their questions and answers—giving and receiving advice. How do you know which advice to follow, which advice is best? All answers in the system have a rating, some answers are provided by the experts others are submitted by members of the community, but all of the answers are have a rating. Each answer can be voted on by the community members dances with the most votes are the ones of the community considers to be the best.

When a user, looks at the question and the answers associated with them and the votes associate with those answers you can see the data in a couple different ways you can see what the experts recommend you can see the People's vote, or the answer that's trending now. And if it anytime you don't like the answers are provided you can add euro out of touch a button you can type in your answer supply any supporting pieces of media including videos audio clips are images impresses submit button sending it into the system for review by the moderators and consideration by the experts in a very short period of time you'll be notified if your answer has been excepted and once it's out into the world you can start support as well (need better way of saying this).

It is also an object of this invention to utilize a Situational Advice Application System and Method, so when faced with a challenging situation, people needed advice, but they love giving advice, but more than that Love to share their opinion.

It is an object of this invention to utilize a Situational Advice Application System and Method that is a community driven advice oriented social network for advice where anyone can ask a question and seek help with a challenging situation or offer their advice or opinion on how to resolve it. Users can follow interesting questions and vote on which answers they think are the best.

It is an object of this invention to utilize a Situational Advice Application System and Method as well as Crowdsourcing to channel the experts' desire to solve a problem and then freely sharing the answer with everyone.

It is another object of this invention to utilize a Situational Advice Application System and Method in this moderated advice app features a panel of experts to help user make the best choice possible. With moderated content and peer feedback, users can see which recommendations have the most support and if they don't like any of the recommendations presented, they can post their own, and let the community decide which “answer” is best.

These and further objects of the invention will become apparent to those skilled in the relevant art and after a study of the present disclosure of the invention.

In addition to the above objects, various other objects of this invention will be apparent from careful reading of this specification including the detail description contained herein below.

### BRIEF DESCRIPTION OF DRAWINGS

These as well as other features of the present invention will become apparent upon reference to the accompanying drawings wherein like numerals designate corresponding parts in the several figures, summarized as follows:

FIG. 1 is a screen shot of the invention displaying the Situational Advice App, wherein the User inputs general information about his/her self;

FIG. 2 is a screen shot of the invention displaying the Situational Advice App, wherein the User inputs characteristic information about his/her self:

FIG. 3 is a screen shot of the invention displaying a Situation, where a user has encountered a girl coming out of a bar alone and the user is asking the Situational Advice App, What to do?

FIG. 4 is a screen shot of the invention displaying a Situation, where a user is about to purchase a used car and the user is asks the Situational Advice App, Should I but a 10 year old used car with 157,000 miles on it for $14,000, What do I do?

FIG. 5 is a screen shot of the invention displaying a Situation, where a user is asking the Situational Advice App, should I go to school part time or full time since the user currently has a job, What do I do?

FIG. 6 is a screen shot of the invention displaying a Situation, where a user has drank to much alcohol and is asking the Situational Advice App, should I go to school part time or full time since the user currently has a job, What do I do?

FIG. 7 is a screen shot of the invention displaying a user's App on his screen where a user has asked a question, What is the best way to cook pasta; and the user's App responds to the user by answering his question.

FIG. 8 illustrates a flow chart as to how the Situational Advise App works with database.

FIG. 9 illustrates a flow chart as to how the Situational Advise App works with 3^{rd} Party Advisors.

FIG. 10 illustrates a flow chart as to how the Situational Advise App works with Expert Panel Advisors.

FIG. 11 illustrates an exemplary system for ranking and managing contextually appropriate advice.

FIG. 12 illustrates an exemplary method for ranking advisor generated advice based on the quality and context of the advice.

FIG. 13 illustrates an exemplary method for ranking advisor generated and context appropriate advice based on the reputation of the advisor submitting the advice.

FIG. 14 illustrates an exemplary method for ranking advisor generated and context appropriate advice based on the quality of the advice and the reputation of the advisor submitting the advice.

FIG. 15 is a List of the Situational Advise App's Categories & Questions regarding:
Girlfriends
Boyfriends
LGBT
Relationships
HookingUp
Conflict Resolution
Jobs & Workplace
Entertainment
Dining
Health
Finance
Substance Abuse
Political Issues
Making Purchases

FIG. 16 is a List of the Situational Advise App's for Interested 3^{rd} Party Companies (i.e. Categories & Questions) regarding:
Retailers
Product Manufactures
Entertainment Companies
Media Events/PR
Political Campaigns
Surveys/Survey Companies

Other features and advantages of the invention will become apparent from the following detailed description, taken in conjunction with the accompanying drawings, which illustrate, by way of example, various features of embodiments of the invention.

### DETAIL DESCRIPTION OF PREFERRED EMBODIMENT

The following detailed description and accompanying drawings are provided for purpose of illustrating and describing precisely the preferred embodiments of the present invention and are not intended to limit the scope of the invention in anyway. It will be understood that various changes in the details, materials arrangements of parts or operational conditions which have been herein described and illustrated in order to explain the nature of the invention may be made by those skilled in the art within the principles and scope of this invention.

The elements identified throughout are exemplary and may include various alternatives, equivalents, or derivations thereof. Various combinations of hardware, software, and computer-executable instructions may be utilized. Program modules and engines may include routines, programs, objects, components, and data structures that effectuate the performance of particular tasks when executed by a processor, which may be general purpose or application specific. Computer-executable instructions and associated data structures stored in a computer-readable storage medium represent examples of programming means for executing the steps of the methods and/or implementing particular system configurations disclosed herein.

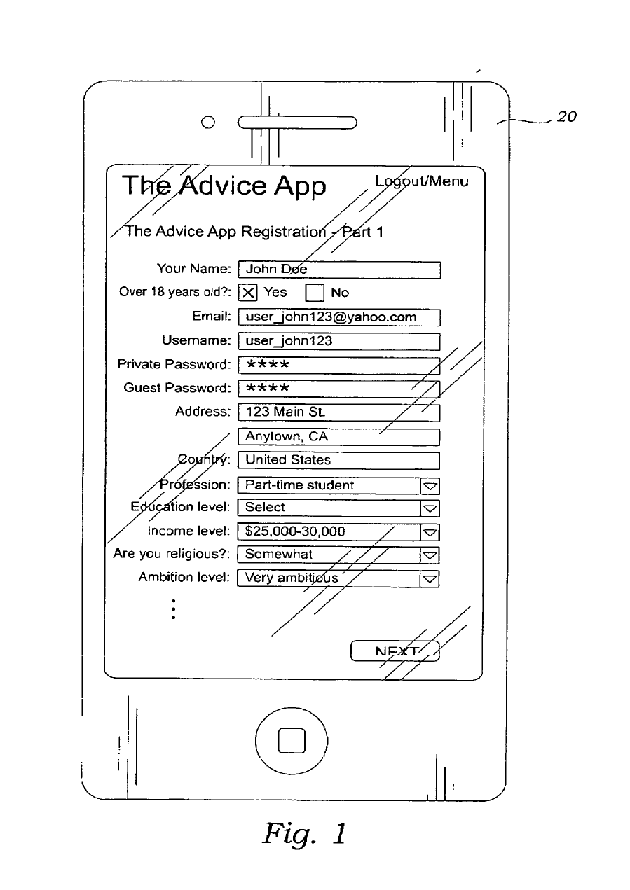

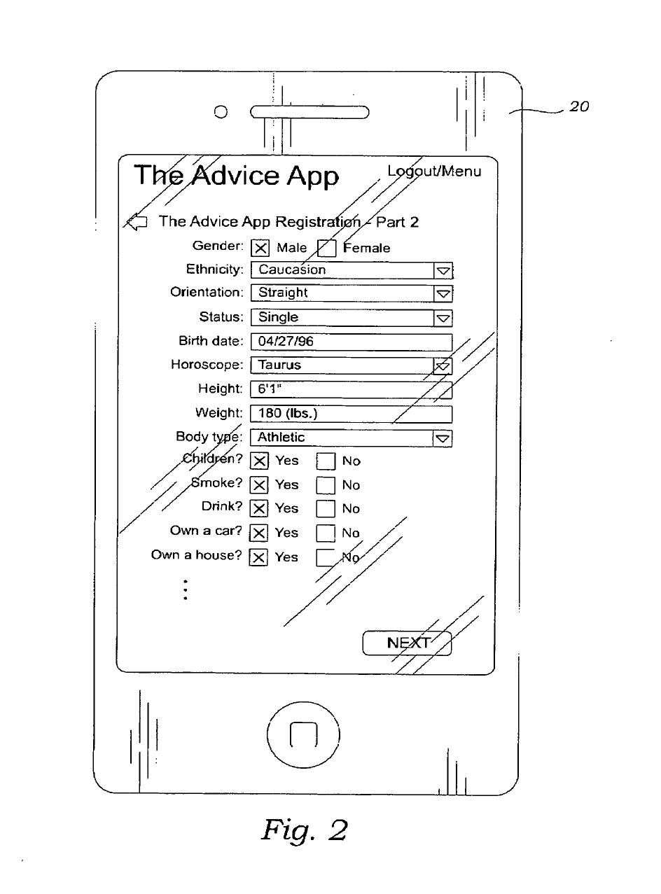

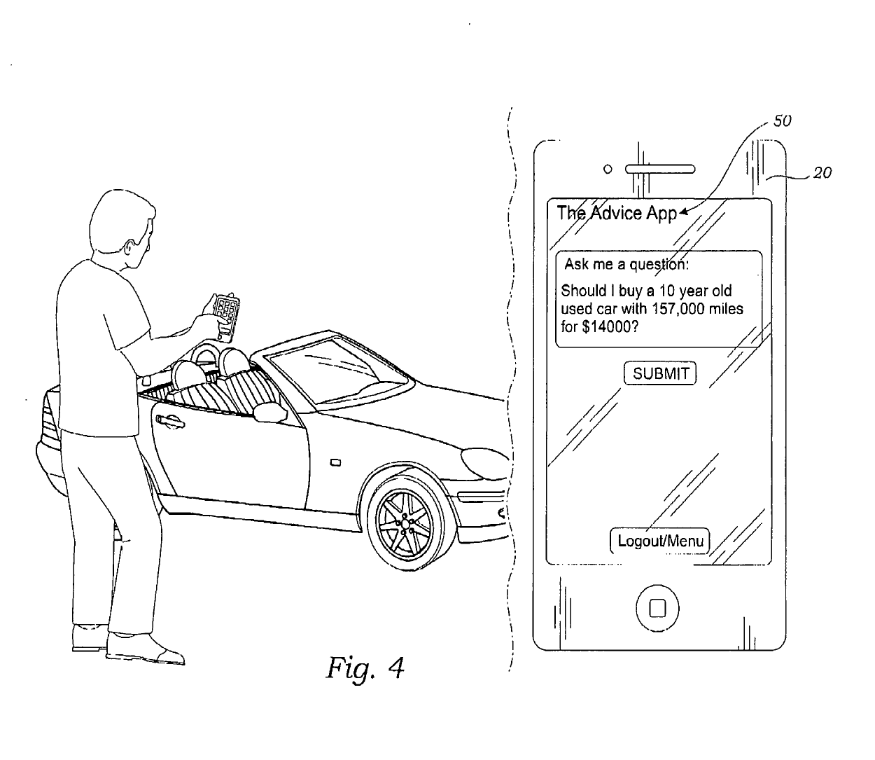

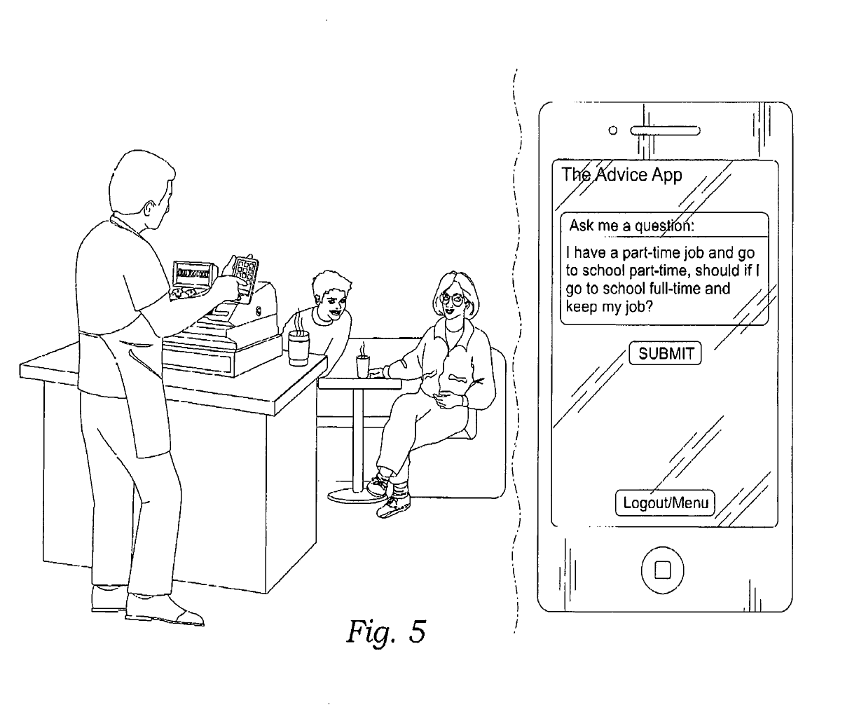

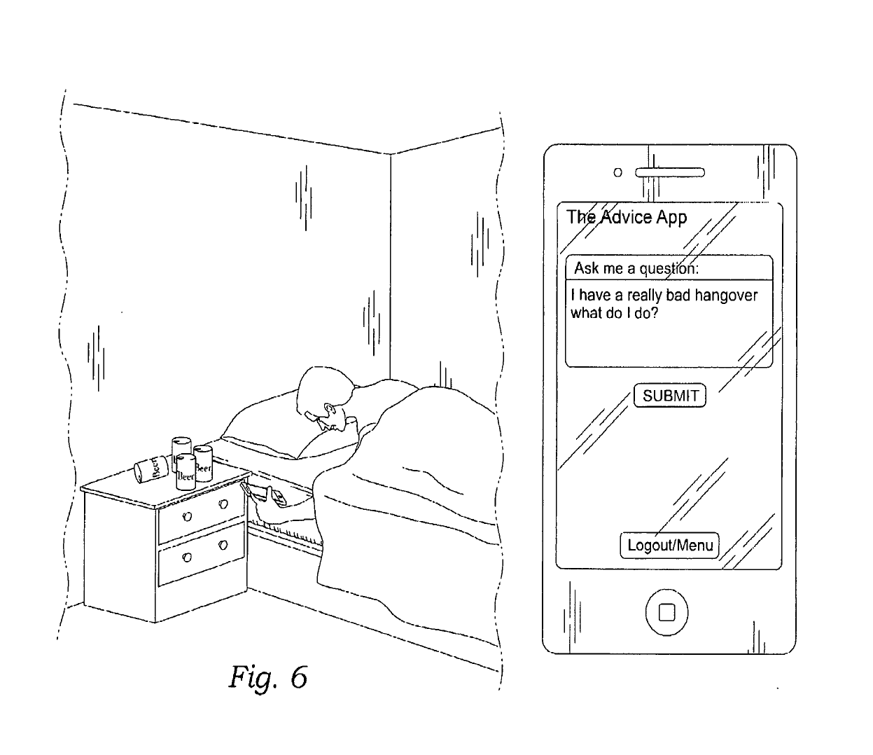

FIGS. 1-7 are screen shots of the invention displaying the Situational Advice App on a phone 20 of a user 40. Wherein the User inputs: general information about his/her self, characteristic information about his/her self, and asks the Situational Advice.

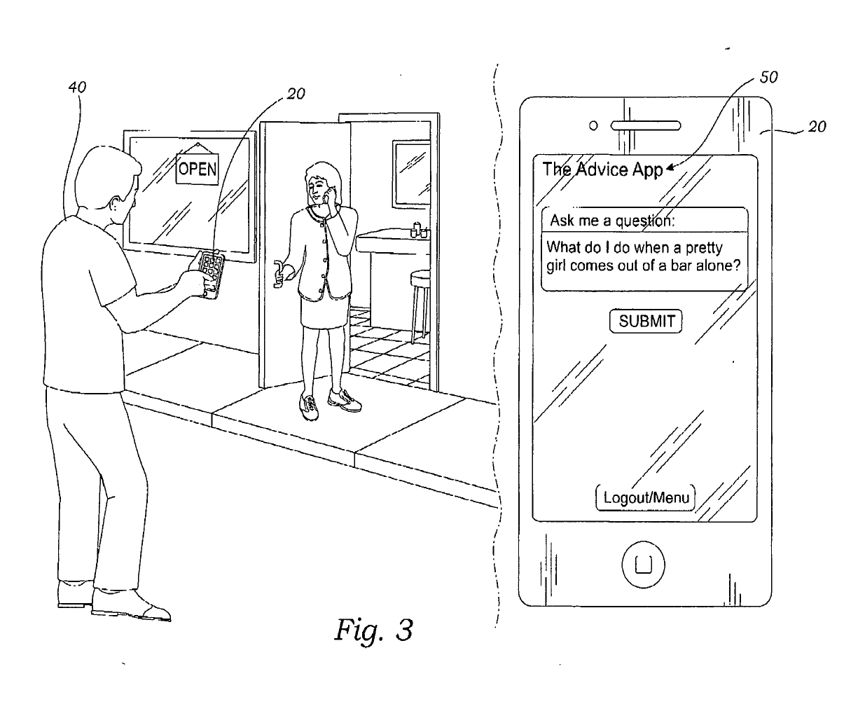

FIGS. 3-6 are screen shots of the invention displaying various Situations, where a user 40 has encountered an issue and is asking for Situational Advice on the App 50, on the user's phone 20.

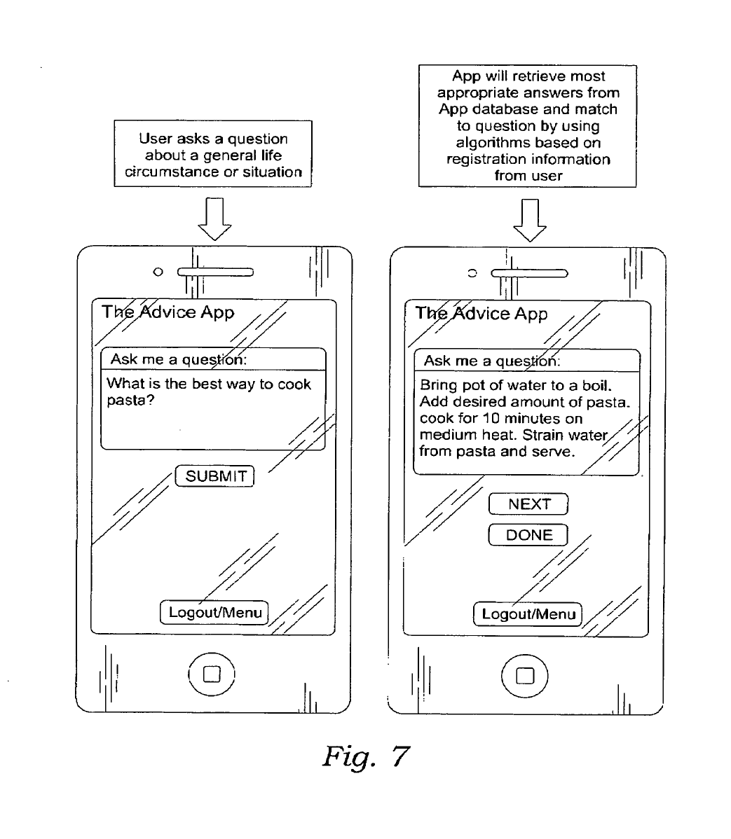

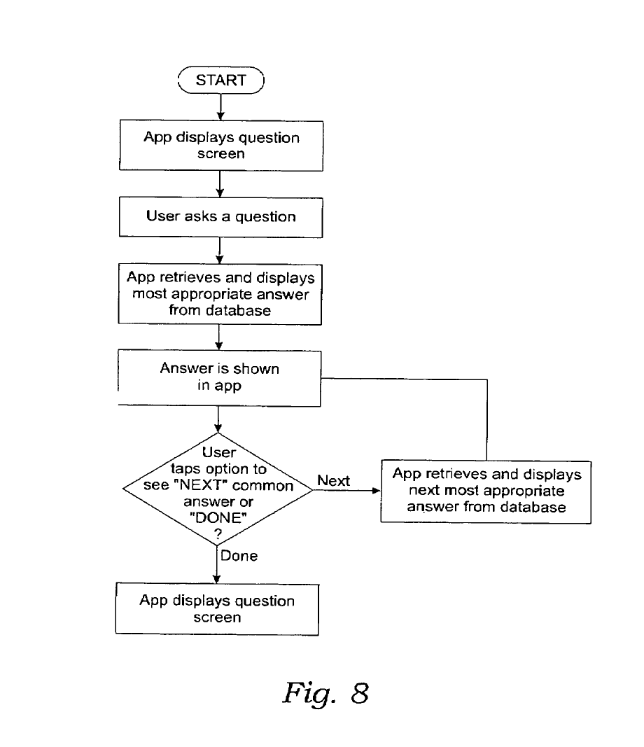

FIG. 7 is a screen shot of the invention displaying a user's App on his screen where a user has asked a question, What is the best way to cook pasta; and the user's App responds to the user by answering his question. And FIG. 8 illustrates a flow chart as to how the Situational Advise App works with database.

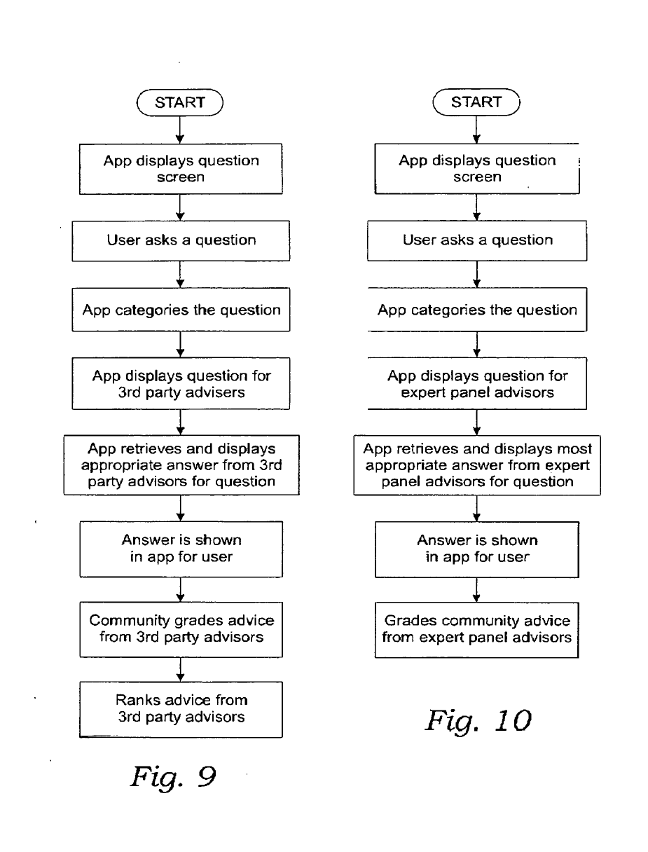

FIGS. 9-10 illustrate how flow charts work with the Situational Advise App and with: (1) 3^{rd} Party Advisors, (2) Expert Panel Advisors, and (3) Friend (wingmen) Advisors (Not Shown), to provide answers.

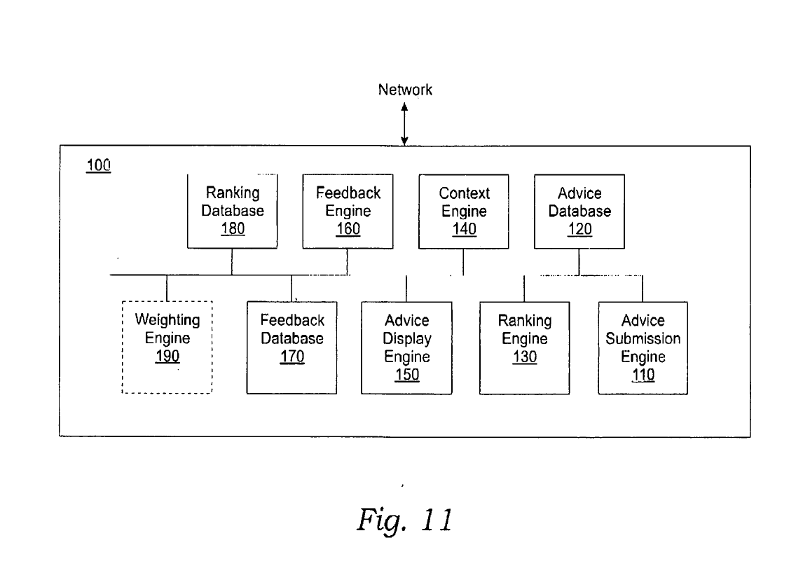

FIG. 11 illustrates an exemplary system 100 for ranking and managing contextually appropriate user-generated game play advice. The system 100 of FIG. 11 includes an advice submission engine 110, advice database 120, ranking engine 130, context engine 140, advice display engine 150, feedback engine 160, feedback database 170, and ranking database 180. In some embodiments (like that illustrated in FIG. 11), the system 100 may also include an optional weighting engine 190. While various engines and databases are described in the context of FIG. 11, an embodiment of the present invention may offer the functionality of each or certain of these engines and databases in an advice management engine or database.

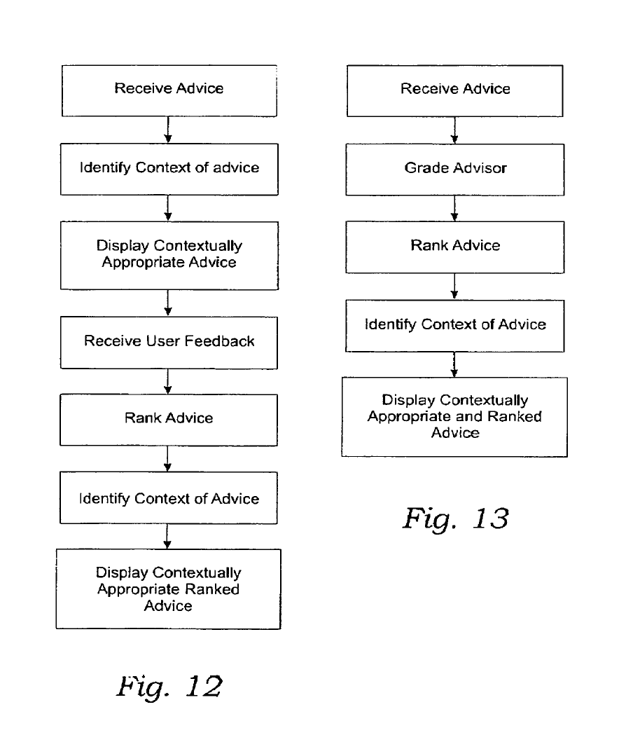

FIG. 12-14 illustrates a few exemplary methods for: (1) ranking advisor generated advice based on the quality and context of the advice, (2) ranking advisor generated and context appropriate advice based on the reputation of the advisor submitting the advice, and (3) ranking advisor generated and context appropriate advice based on the quality of the advice and the reputation of the advisor submitting the advice.

The method of FIG. 12 may also operate subject to a predetermined schedule whereby the ranking engine 130 updates the ranking database 180 at regular intervals. Context may be similarly updated and revised. Once the ranking database 180 is updated as a result of a regularly scheduled ranking operation, the newly updated ranking information may be pushed to the advice display engine 150 for display to the community of users in conjunction with the advice retrieved from game play advice database 120. Alternatively, the updated information in the ranking database 180 may available for access in response to a user request or query. A user request for ranking information may instantiate the ranking operation and the subsequent display of ranked advice.

The method of FIG. 13 may operate in real-time or substantially in real-time. Like the method of FIG. 12, such real-time functionality may be effectuated using an asynchronous programming language whereby the most recent advice rankings vis-à-vis a user grade are retrieved from the ranking database 180 and displayed via the advice display engine 150. In this matter, advice rankings are updated as user grading is calculated.

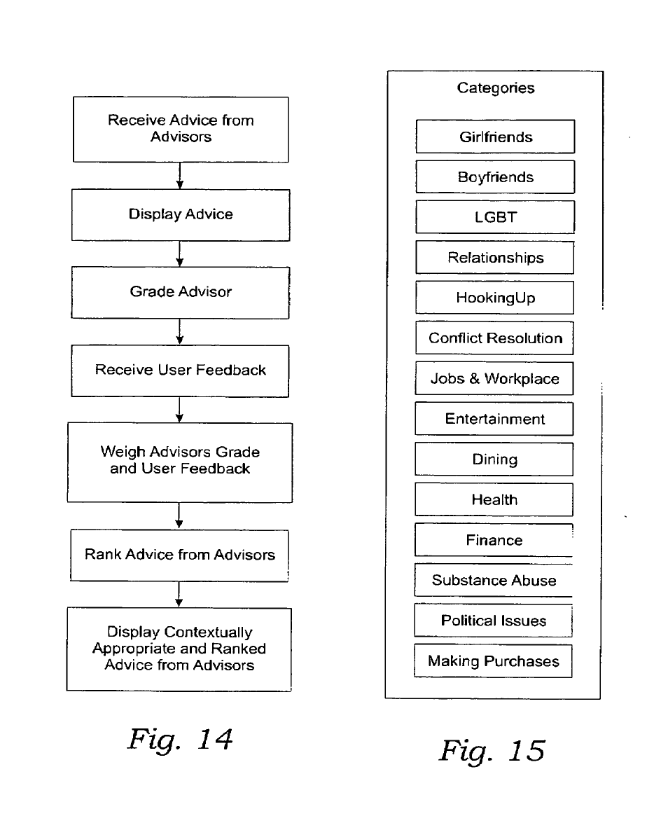

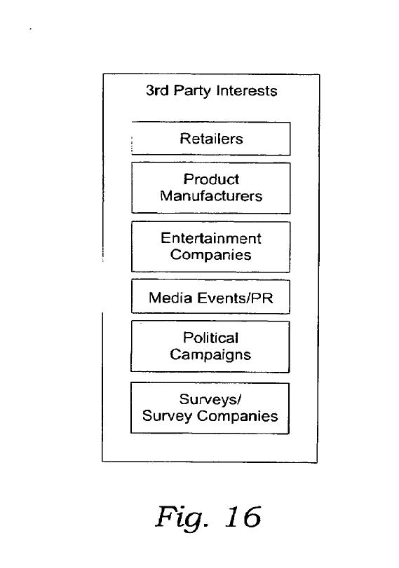

FIG. 14 illustrates an exemplary method for ranking user-generated and context appropriate advice based on the quality of the advice and the reputation of the user submitting the advice. The steps identified in FIG. 14 (and the order thereof) are exemplary and may include various alternatives, combinations, equivalents, or derivations thereof including but not limited to the order of execution of the same. The steps of the process of FIG. 14 (and its various alternatives) may be embodied in hardware or software including a computer-readable storage medium (e.g., optical disc, memory card, or hard drive) including instructions executable by the processor of a computing device.

FIG. 15 is a List of the Situational Advise App's Categories & Questions regarding: Girlfriends, Boyfriends. LGBT, Relationships, HookingUp, Conflict Resolution, Jobs & Workplace. Entertainment, Dining, Health, Finance, Substance Abuse, Political Issues, and Making Purchases.

A system 100 for managing user-generated situational advice from one or more advisors, the system comprising: a situational advice submission engine 110 coupled to a server and executable by a processor to receive situational advice submissions over a network; a ranking engine 130 stored on a server and executable by a processor to: allocate a ranking to the situational advice submissions received over the network, and allocate a grade to a user in a community of users for the situational advice based on a performance of the user with respect to the advice given; a situational advice display engine 150 stored on a server and executable by a processor to display the situational advice submissions in accordance with the ranking allocated by the ranking engine 130; and a feedback engine 160 stored on a server and executable by a processor to receive feedback from a community of users with respect to the quality of the situational advice displayed by the situational advice display engine 150, wherein the feedback engine 160 and the ranking engine 130 operate to allocate a new ranking to the advice in accordance with the feedback received from the community of users and on the user's performance in giving advice, the advice being subsequently displayed by the situational advice display engine 150 in accordance with the new ranking.

Wherein the ranking allocated by the ranking engine is selected from a group consisting of numeric, characteristic, binary, and percentage-based rankings.

Wherein the ranking engine further executes instructions stored on a server to apply a tie-breaker to advice receiving an equal ranking from the ranking engine.

Wherein the situational advice display engine operates using an asynchronous programming language to continually update displayed advice submissions in accordance with a most recent new ranking as allocated by the feedback engine and the ranking engine.

Wherein the situational advice display engine displays situational advice submissions in accordance with a most recent new ranking as allocated by the feedback engine and the ranking engine according to a predetermined schedule.

Wherein the situational advice display engine displays situational advice submissions in accordance with a most recent new ranking as allocated by the feedback engine and the ranking engine in response to a user query.

Wherein the feedback engine further executes instructions stored on a server to receive feedback from a community of users with respect to the reputation of the user submitting situational advice.

Further comprising a weighting engine, the weighting engine stored on a server and executable by a processor to allocate a first value to the feedback received from the community of users with respect to the quality of the situational advice and a second value to the reputation of the user submitting the situational advice, the first and the second value proportionally affecting the new ranking allocated to the situational advice.

Further comprising a weighting engine, the weighting engine stored on a server and executable by a processor to allocate a first value to the feedback received from the community of users with respect to the quality of the situational advice and a second value to the user grade received from the community of users, the first and the second value proportionally affecting the new ranking allocated to the situational advice.

A computer-implemented method for managing user-generated advice, the method comprising: receiving new situational advice from a user through a user interface generated by a situational advice submission engine, the situational advice submission engine coupled to a server and executable by a processor, and executing instructions stored in a memory, in which execution of instructions by the processor: displays the new situational advice to a community of users, the new situational advice displayed in a default ranking position and in conjunction with previously received situational advice, the situational advice displayed in a manner that is relevant with respect to a present context of situational, the new situational advice displayed by a situational advice display engine that utilizes an asynchronous programming language; receives feedback associated with the quality of the new situational advice or the previously received situational advice, the feedback received from the community of users, the feedback received via a feedback engine generating a prompt that is displayed in an immediate context of the new situational advice or the previously received situational advice; ranks the new situational advice against the previously received situational advice based on the feedback received from the community of users; and displays the new situational advice in conjunction with the previously received situational advice via the situational advice display engine, the new situational advice and the previously received situational advice displayed in accordance with the ranking of the new situational advice and the previously received situational advice, wherein the new situational advice is no longer displayed in the default ranking position and the new situational advice is displayed in a manner that is relevant with respect to a present context of situational, the ranking allocated by a ranking engine.

Wherein the feedback includes the relevance of the context in which the situational advice was displayed.

Wherein the feedback is selected from a group consisting of numeric, characteristic, and binary feedback, the feedback including user commentary.

Wherein ranking the new situational advice in a position that is not the default position occurs substantially in real-time based on voting.

Wherein ranking the new situational advice in a position that is not the default position occurs according to a predetermined schedule.

Wherein ranking the new situational advice in a position that is not the default position occurs in response to a user query.

A method for displaying user-generated situational advice, the method comprising: receiving new situational advice from a first user, by a situational advice submission engine coupled to a server and executable by a processor, the first user having previously received feedback from a community of users; and executing instructions stored in memory, wherein execution of instructions by the processor: allocates a grade to the first user for an advice based on a performance of the first user with respect to the advice, by a ranking engine, ranks the new situational advice against previously received situational advice based on user feedback received from the community of users and on the performance of the advice of the first user, by the ranking engine, the previously received situational advice having been submitted by at least a second user, the at least a second user having previously received feedback from the community of users, and displays the new situational advice in conjunction with the previously received situational advice, the new situational advice and previously received situational advice displayed in accordance with the ranking of the new situational advice and the previously received situational advice, the new situational advice and previously received situational advice displayed by a situational advice display engine.

Wherein the feedback is selected from a group consisting of numeric, characteristic, and binary feedback, the feedback including user commentary.

Wherein ranking and displaying the new situational advice occurs substantially in real-time.

Wherein ranking and displaying the new situational advice occurs according to a predetermined schedule.

Wherein ranking and displaying the new situational advice occurs in response to a user query.

A method for managing user-generated situational advice, the method comprising: receiving new situational advice from a user by a situational advice submission engine coupled to a server and executable by a processor; and executing instructions stored in memory, wherein execution of instructions by a processor: displays the new situational advice to a community of users, the new situational advice displayed in a default ranking position and in conjunction with previously received situational advice, the new situational advice displayed by a situational advice display engine, allocates a grade to the user for a advice based on a performance of the user with respect to the advice, by a ranking engine, ranks the new situational advice against the previously received situational advice, by the ranking engine, the previously received situational advice having been submitted by at least a second user, the at least a second user having previously received feedback from the community of users, receives feedback associated with the quality of the new situational advice and the quality of the previously received situational advice, the feedback received from the community of users, by a feedback engine, assigns a first weighting value to the user feedback and a second weighting value to the feedback associated with the quality of the situational advice, by the ranking engine, ranks the new situational advice against the previously received situational advice based on the feedback received from the community of users, a performance of the advice of at least a second user, and the feedback associated with the quality of the situational advice, in accordance with the first weighting value and the second weighting value, by the ranking engine, removes the new situational advice from the default ranking position, by the ranking engine, and displays the new situational advice in conjunction with the previously received situational advice, the new situational advice and the previously received situational advice displayed in accordance with the ranking of the new situational advice and the previously received situational advice, the new situational advice and the previously received situational advice displayed by the situational advice display engine.

The situational advice is pervasive and easily accessible to users via a computer or a smart phone. And to bring millions up to speed on social interaction, by providing real life advice in an option of trivia forum. It will help people interact better with others when in front of someone rather than behind a computer or phone. This will be used to replace advice columns in magazines.

In the advent of more restaurants and bars using technology, this has left us open opportunity to help streamline our business while integrating our app into their interface. As technology advances our app has positioned a perfect fit for these businesses.

We will be the first app game geared towards situations based on the real life environment for our users. Through development phase we have encountered no other direct idea or concept.

Ultimately we want the app to give real time advice for the individual situation. We don't believe this has been done before.

Must be compatible with android auto and apple car play, and any future technology based platforms.

While other advice apps have been developed, they are more like forums where people discuss issues. Our invention is situational advice specific to the user, in real time at your fingertips to make you excel in life.

The app itself at first will be designed as a game. A text based role-playing game. The player will be given a scenario starting at the beginning of the day. You will be given a series of choices for each mini situation or problem. Each day ends with a very difficult situation that plays a huge role in deciding the fate of the character for the following day since the game is text based.

The original app launch will be games that are text based ASCII characters and extremely simple. Takes people back to old school games with the ability to be sponsored and have affiliates.

People can get the ultimate in advice for the many scenarios we came across in life while climbing up the leader board for picking the best play for that scenario.

Based on the lack of social skills young people have these days, due to the tech era.

It is an object of this invention in an alternative embodiment to create a game wherein the user will role play by providing real life experiences to trigger Situational Advice in the form of a game. What's The Play is a social gaming system that challenges player to choose the “best” response to various real-life situations and encounters. Using the well know trivia game format, users are presented with a series of situational questions from one or more categories and scored based upon their choices and responses. Users answers are scored in one of three ways:
Expert Opinion—the users choice is scored against the expert advice offered by whats the plays content designers
Mob Rules—the users choice is scored based upon the cumulative choices of every user who has answered the question.
Survey Says—the users choice is scored against all the players currently playing in the same gaming session as the user.

The application is designed to provide a virtual playing field for real-life social party games and as such the application is locationally aware, using the players mobile to device to determine the current location, allowing users to connect with and interact with players at their current or nearby locations and to compete as individuals and in teams. Integration with the devices calendar and push notification system allow players to schedule and take part in current and upcoming events in the real-world locations around them. Integration and hooks into many of the most popular social media systems allows users to share their victories, request backup, and invite friends to participate with them. Commercial establishments and venues such as bars and restaurants can opt into the system, providing contextual playing fields for the competitors in the application. This physical establishments can sponsor recurring or one-off events, providing users with the chance to compete in a real world venue for fun and fame, and potentially some prizes as well.

Interesting or unique points for the system could include:
The use of the mobile device as a playing screen for a real-world/location based competition.
Geofencing of play locations and venues.
Locationally aware gameplay, where the device alerts the user as they cross into a geofence, potentially altering the mode and form of play.
Use of the devices maps application to help players find physical situational locations.

While the description above refers to particular embodiments of the present invention, it will be understood that many modifications may be made without departing from the spirit thereof. The presently disclosed embodiments are therefore to be considered in all respects as illustrative and not restrictive.

I claim:

1. A system for managing user-generated questions regarding situational advice from one or more advisors, the system comprising:
a situational advice submission engine coupled to a server and executable by a processor to receive situational advice submissions over a network;
a ranking engine stored on a server and executable by a processor to: allocate a ranking to the situational advice submissions received over the network, and allocate a grade to an advisor in a community of advisors for the situational advice based on a performance of the advisor with respect to the advice given;
a situational advice display engine stored on a server and executable by a processor to display the situational advice submissions in accordance with the ranking allocated by the ranking engine;
a feedback engine stored on a server and executable by a processor to receive feedback from a community of advisors with respect to the quality of the situational advice displayed by the situational advice display engine, wherein the feedback engine and the ranking engine operate to allocate a new ranking to the advice in accordance with the feedback received from the community of advisors and on the advisor's performance in giving advice, the advice being subsequently displayed by the situational advice display engine in accordance with the new ranking; and
wherein when a user creates a question seeking situational advice and then said user submits the question to said network, said question is categorized by said network and then the question is available for display to said advisors;
wherein when said advisors displays said question and said advisors elects to answer said question then said answer to said question is submitted to said network, then said user can review said answer submitted by said advisors; and
wherein said advisors have submitted said answer to said network then said community grades said advice from said advisors and also ranks said advise from all of said advisors.

2. The system of claim 1, wherein the ranking allocated by the ranking engine is selected from a group consisting of numeric, characteristic, binary, and percentage-based rankings.

3. The system of claim 1, wherein the ranking engine further executes instructions stored on a server to apply a tie-breaker to advice receiving an equal ranking from the ranking engine.

4. The system of claim 1, wherein the situational advice display engine operates using an asynchronous programming language to continually update displayed advice submissions in accordance with a most recent new ranking as allocated by the feedback engine and the ranking engine.

5. The system of claim 1, wherein the situational advice display engine displays situational advice submissions in accordance with a most recent new ranking as allocated by the feedback engine and the ranking engine according to a predetermined schedule.

6. The system of claim 1, wherein the situational advice display engine displays situational advice submissions in accordance with a most recent new ranking as allocated by the feedback engine and the ranking engine in response to said user query.

7. The system of claim 1, wherein the feedback engine further executes instructions stored on a server to receive feedback from said community of advisors with respect to the reputation of the advisor submitting situational advice.

8. The system of claim 7, further comprising a weighting engine, the weighting engine stored on a server and executable by a processor to allocate a first value to the feedback received from the community of advisors with respect to the quality of the situational advice and a second value to the reputation of the advisor submitting the situational advice, the first and the second value proportionally affecting the new ranking allocated to the situational advice.

9. The system of claim 1, further comprising a weighting engine, the weighting engine stored on a server and executable by a processor to allocate a first value to the feedback received from the community of advisors with respect to the quality of the situational advice and a second value to the advisor grade received from the community of advisors, the first and the second value proportionally affecting the new ranking allocated to the situational advice.

10. A computer-implemented method for managing user-generated advice, the method comprising:
receiving new situational advice from a user through a user interface generated by a situational advice submission engine, the situational advice submission engine coupled to a server and executable by a processor, and executing instructions stored in a memory, in which execution of instructions by the processor displays the new situational advice to a community of users, the new situational advice displayed in a default ranking position and in conjunction with previously received situational advice, the situational advice displayed in a manner that is relevant with respect to a present context of situational, the new situational advice displayed by a situational advice display engine that utilizes an asynchronous programming language; receives feedback associated with the quality of the new situational advice or the previously received situational advice, the feedback received from the community of users, the feedback received via a feedback engine generating a prompt that is displayed in an immediate context of the new situational advice or the previously received situational advice; ranks the new situational advice against the previously received situational advice based on the feedback received from the community of users; and displays the new situational advice in conjunction with the previously received situational advice via the situational advice display engine, the new situational advice and the previously received situational advice displayed in accordance with the ranking of the new situational advice and the previously received situational advice, wherein the new situational advice is no longer displayed in the default ranking position and the new situational advice is displayed in a manner that is relevant with respect to a present context of situational, the ranking allocated by a ranking engine.

11. The method of claim 10, wherein the feedback includes the relevance of the context in which the situational advice was displayed.

12. The method of claim 10, wherein the feedback is selected from a group consisting of numeric, characteristic, and binary feedback, the feedback including user commentary.

13. The method of claim 10, wherein ranking the new situational advice in a position that is not the default position occurs substantially in real-time based on voting.

14. The method of claim 10, wherein ranking the new situational advice in a position that is not the default position occurs according to a predetermined schedule.

15. The method of claim 10, wherein ranking the new situational advice in a position that is not the default position occurs in response to a user query.

16. A method for displaying user-generated situational advice, the method comprising: receiving new situational advice from a first user, by a situational advice submission engine coupled to a server and executable by a processor, the first user having previously received feedback from a community of users; and executing instructions stored in memory, wherein execution of instructions by the processor: allocates a grade to the first user for an advice based on a performance of the first user with respect to the advice, by a ranking engine, ranks the new situational advice against previously received situational advice based on user feedback received from the community of users and on the performance of the advice of the first user, by the ranking engine, the previously received situational advice having been submitted by at least a second user, the at least a second user having previously received feedback from the community of users, and displays the new situational advice in conjunction with the previously received situational advice, the new situational advice and previously received situational advice displayed in accordance with the ranking of the new situational advice and the previously received situational advice, the new situational advice and previously received situational advice displayed by a situational advice display engine.

17. The method of claim 16, wherein the feedback is selected from a group consisting of numeric, characteristic, and binary feedback, the feedback including user commentary.

18. The method of claim 16, wherein ranking and displaying the new situational advice occurs substantially in real-time.

19. The method of claim 16, wherein ranking and displaying the new situational advice occurs according to a predetermined schedule.

20. The method of claim 16, wherein ranking and displaying the new situational advice occurs in response to a user query.

21. A method for managing user-generated situational advice, the method comprising: receiving new situational advice from a user by a situational advice submission engine coupled to a server and executable by a processor; and executing instructions stored in memory, wherein execution of instructions by a processor: displays the new situational advice to a community of users, the new situational advice displayed in a default ranking position and in conjunction with previously received situational advice, the new situational advice displayed by a situational advice display engine, allocates a grade to the user for a advice based on a performance of the user with respect to the advice, by a ranking engine, ranks the new situational advice against the previously received situational advice, by the ranking engine, the previously received situational advice having been submitted by at least a second user, the at least a second user having previously received feedback from the community of users, receives feedback associated with the quality of the new situational advice and the quality of the previously received situational advice, the feedback received from the community of users, by a feedback engine, assigns a first weighting value to the user feedback and a second weighting value to the feedback associated with the quality of the situational advice, by the ranking engine, ranks the new situational advice against the previously received situational advice based on the feedback received from the community of users, a performance of the advice of at least a second user, and the feedback associated with the quality of the situational advice, in accordance with the first weighting value and the second weighting value, by the ranking engine, removes the new situational advice from the default ranking position, by the ranking engine, and displays the new situational advice in conjunction with the previously received situational advice, the new situational advice and the previously received situational advice displayed in accordance with the ranking of the new situational advice and the previously received situational advice, the new situational advice and the previously received situational advice displayed by the situational advice display engine.
